(19) United States
(12) Patent Application Publication
(10) Pub. No.: US 2025/0153387 A1
(43) Pub. Date: May 15, 2025

(54) WORKPIECE HANDLING TOOL

(71) Applicant: Gerardo Ricalday, Pacoima, CA (US)

(72) Inventor: Gerardo Ricalday, Pacoima, CA (US)

(21) Appl. No.: 18/389,564

(22) Filed: Nov. 14, 2023

(51) Int. Cl. B27B 25/10

(52) U.S. Cl. CPC B27B 25/10

(57) ABSTRACT

A workpiece handling tool for handling a workpiece without endangering a user's hands near a hazard includes a tool head with a first engagement member and a second engagement member which are spaced from each other. The first and second engagement members are resiliently bendable and spaced at such a distance that they may bend to accommodate the workpiece between the first and second engagement members and clamp onto the workpiece. A handle is attached to the tool head to facilitate grasping the workpiece handling tool via a hand.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to workpiece handling tools and more particularly pertains to a new workpiece handling tool for handling a workpiece without endangering a user's hands near a hazard.

### (2) Description of Related Art Including Information Disclosed Under 37 CFR 1.97 and 1.98

The prior art relates to workpiece handling tools, including those with opposite jaw members that clamp onto a workpiece. Some such workpiece handling tools have spikes, teeth, or similar to engage the workpiece. However, the prior art fails to describe such a tool which has resiliently bendable engagement members that accommodate the workpiece between the engagement members. Such a tool facilitates handling the workpiece via placing one of the engagement members against the workpiece and pivoting the tool to bring another engagement member against the workpiece on an opposite side, thereby clamping the workpiece between the pair of engagement members.

### BRIEF SUMMARY OF THE INVENTION

An embodiment of the disclosure meets the needs presented above by generally comprising a tool head with a base, a first engagement member, and a second engagement member. The base has a first side and a second side positioned opposite each other. The first and second engagement members are coupled to the base on the first side and are spaced from each other at a distance such that the tool head is configured to receive a workpiece such as a wooden beam between the first and second engagement members. At least one of the first and second engagement members is resiliently bendable such that the at least one of the first and second engagement members bends to accommodate to the workpiece when receiving the workpiece between the first and second engagement members. A handle is coupled to the tool head and is configured to facilitate grasping of the handle with a hand.

Another embodiment of the disclosure includes a method of handling a workpiece with a workpiece handling tool. The method comprises grasping a handle of the workpiece handling tool with a hand and positioning a tooth of a first engagement member of a tool head of the workpiece handling tool in abutment with a first surface of the workpiece. The tool head is then pivoted about a contact point between the tooth and the workpiece, thereby moving a second engagement member of the tool head toward a second surface of the workpiece opposite the first surface. At least one of the first and second engagement members is bent via pressing the same against the workpiece to accommodate the workpiece between the first and second engagement members. The at least one of the first and second engagement members is resilient such that the tool head clamps the workpiece. Then the workpiece is positioned in a desired position via positioning the workpiece handling tool with the hand.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a workpiece handling tool according to an embodiment of the disclosure.

FIG. 2 is a bottom rear side perspective view of an embodiment of the disclosure.

FIG. 3 is a side view of an embodiment of the disclosure.

FIG. 4 is an in-use view of an embodiment of the disclosure showing a tooth of a first engagement member abutting a workpiece.

FIG. 5 is an in-use view of an embodiment of the disclosure showing a tool head clamping a workpiece.

FIG. 6 is an in-use view of an embodiment of the disclosure depicting a tool head clamping a workpiece and positioning the workpiece near a hazard, while a hand grasping the workpiece handling tool is spaced away from the hazard.

FIG. 7 is an in-use detail view of an embodiment of the disclosure depicting a tool head clamping a workpiece and positioning the workpiece near a hazard.

### DETAILED DESCRIPTION OF THE INVENTION

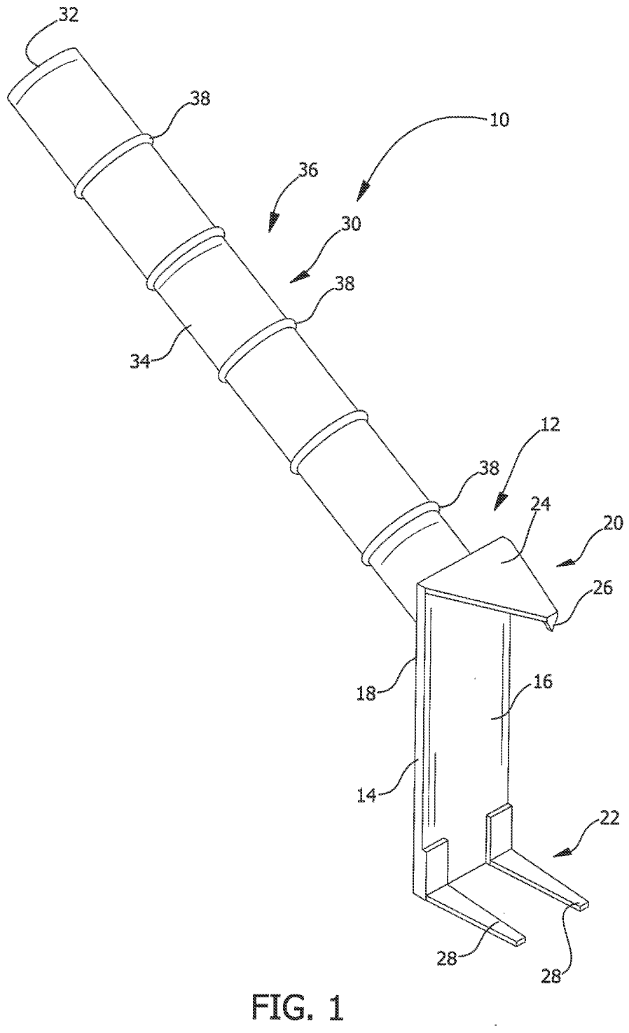

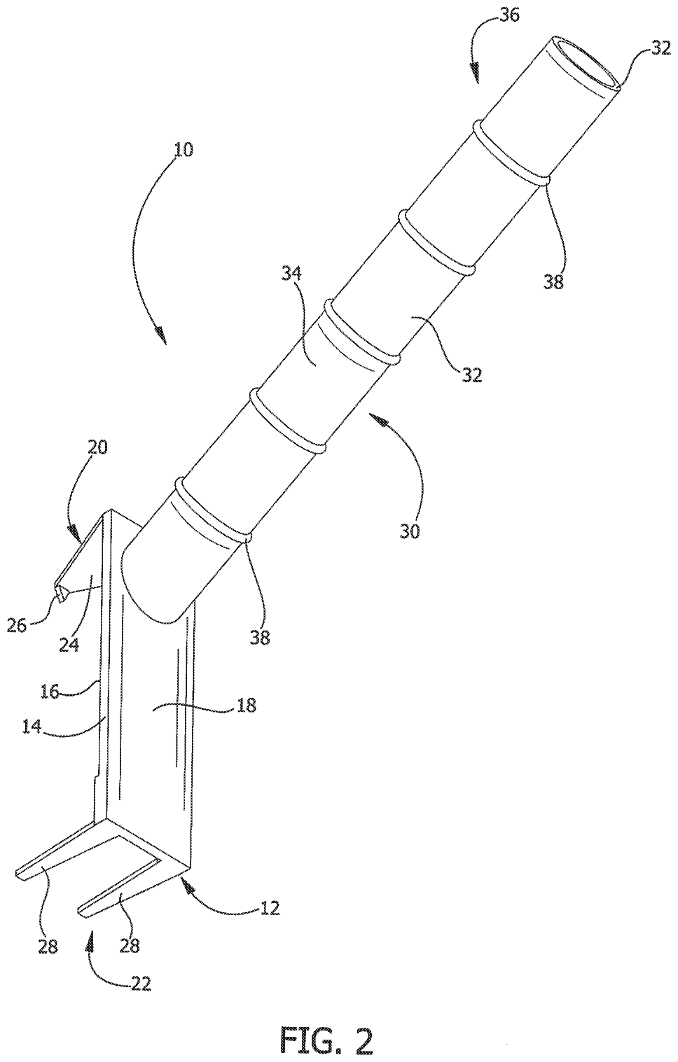

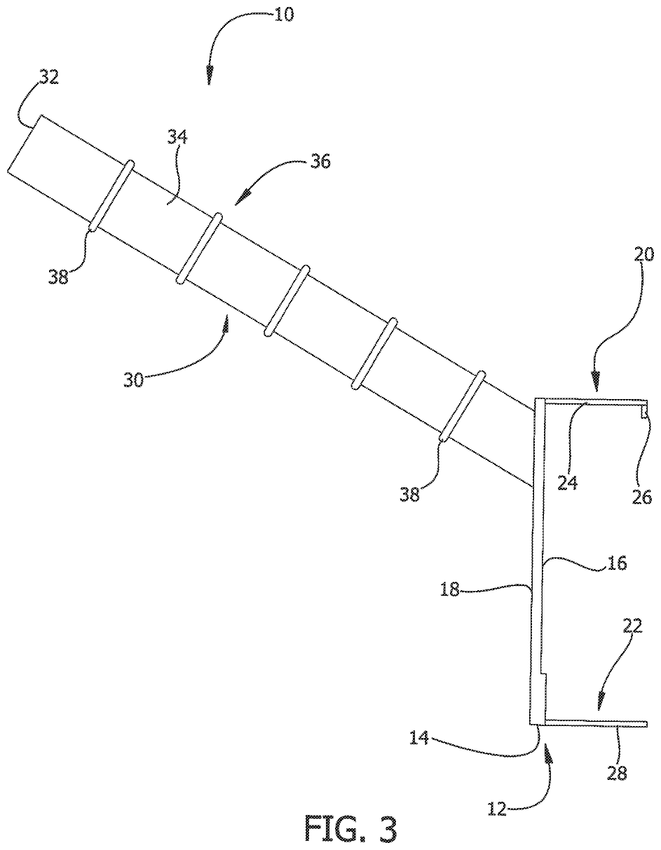

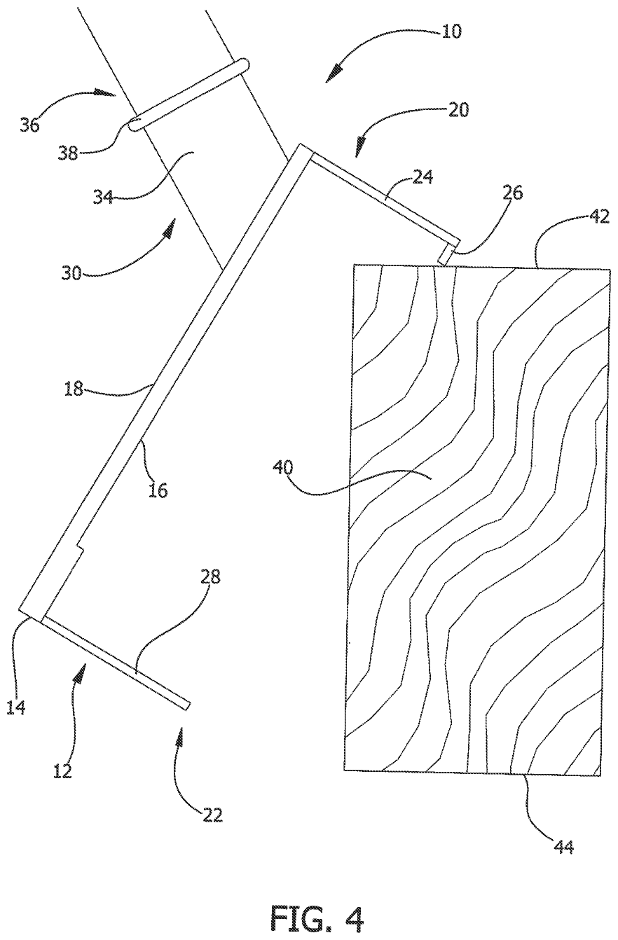

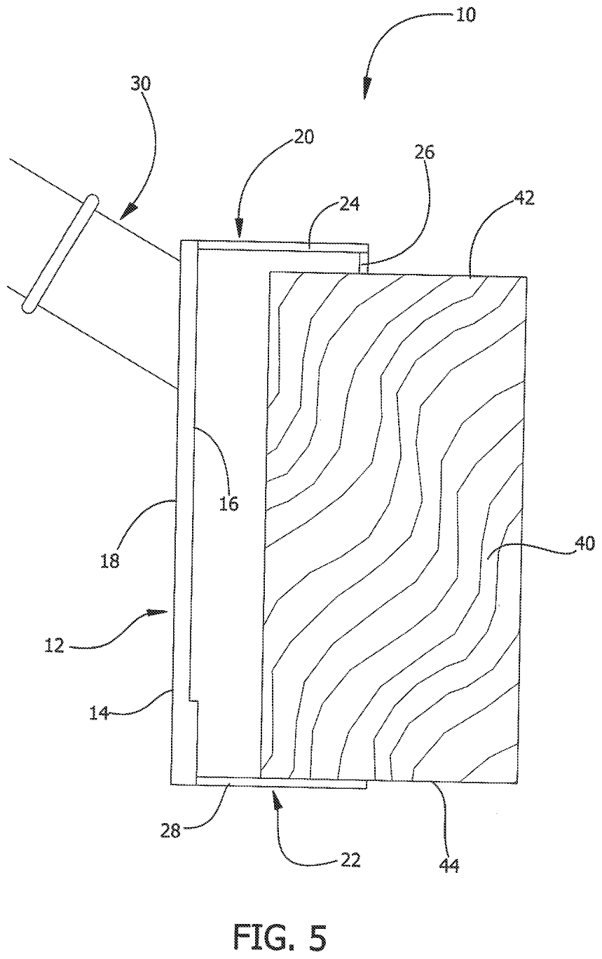

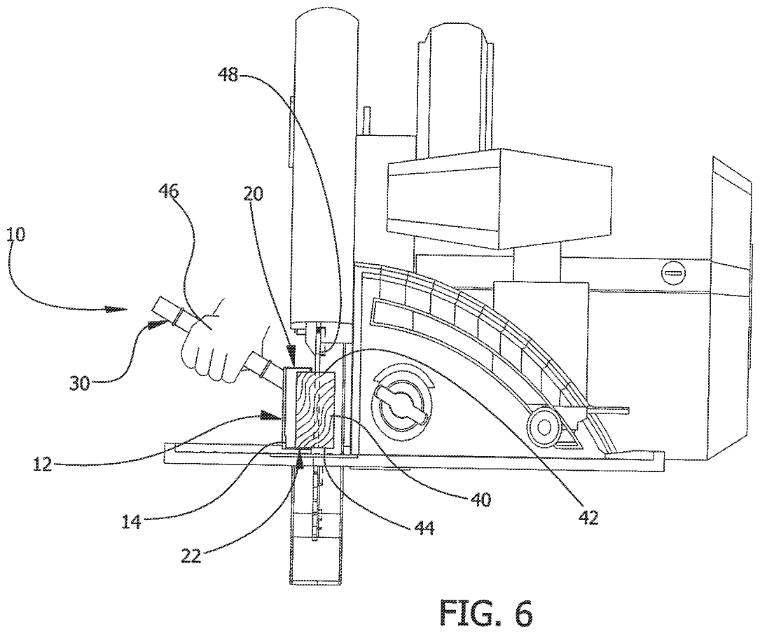

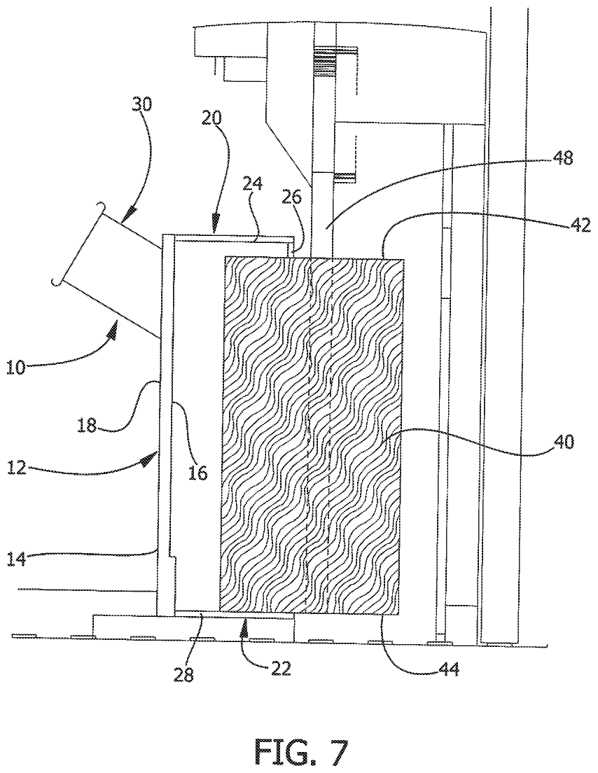

With reference now to the drawings, and in particular to FIGS. 1 through 7 thereof, a new workpiece handling tool embodying the principles and concepts of an embodiment of the disclosure and generally designated by the reference numeral 10 will be described.

As best illustrated in FIGS. 1 through 7, the workpiece handling tool 10 generally comprises a tool head 12 having a base 14, a first engagement member 20, and a second engagement member 22. The base 14 has a first side 16 and a second side 18 positioned opposite each other. The first and a second engagement members 20, 22 are coupled to the base 14 on the first side 16. The first and second engagement members 20, 22 are spaced from each other at a distance such that the tool head 12 is configured to receive a workpiece 40 such as a wooden beam between the first and second engagement members 20, 22. At least one of the first and second engagement members 20, 22 is resiliently bendable such that the at least one of the first and second engagement members 20, 22 bends to accommodate the workpiece 40 when receiving the workpiece 40 between the first and second engagement members 20, 22. The second engagement member 22 comprises a pair of prongs 28 which are spaced from each other. The first engagement member 20 comprises an extension panel 24 and a tooth 26. The extension panel 24 is coupled to and extends between the base 14 and the tooth 26, and the tooth 26 points toward the second engagement member 22. The extension panel 24 tapers from the base 14 to the tooth 26. The extension panel 24 of the first engagement member 20 and the prongs 28 of the second engagement member 22 may comprise a sheet metal material, for example, to facilitate a resilient bending.

A handle 30 is coupled to the tool head 12 and is positioned on the second side 18 of the base 14. The handle 30 is elongated between the tool head 12 and a distal end 32 of the handle 30 with respect to the tool head 12. The handle 30 forming an acute angle with an axis extending between the first and second engagement members 20, 22 and extends away from the tool head 12 in a direction away from the second engagement member 22. The handle 30 has a cylindrical shape but other elongated shapes may be suitable, including those contoured for grasping by a hand 46. A grip 36 is mounted to a perimeter 34 of the handle 30 to frictionally enhance the handle 30. The grip 36 comprises a plurality of rings 38 each of which extends around the perimeter 34 of the handle 30. The rings 38 are spaced at intervals between the tool head 12 and the distal end 32. The grip 36 comprises rubber but may comprise silicone or another suitable friction enhancing material.

In use, the handle 30 is grasped by the hand 46, and the tooth 26 is positioned in abutment with a first surface 42 of the workpiece 40. The tool head 12 is pivoted about a contact point between the tooth 26 and the workpiece 40 to move the second engagement member 22 toward a second surface 44 of the workpiece 40 opposite the first surface 42. Upon forcing the tool head 12 against the workpiece 40 to receive the workpiece 40 between the first and second engagement members 20, 22, at least one of the first and second engagement members 20, 22 resiliently bends, which thereby facilitates the tool head 12 to clamp the workpiece 40. The workpiece 40 is positioned as desired while grasping the handle 30 with the hand 46. In situations where the workpiece 40 is positioned near saws 48 or other hazard, the hand 46 is thereby maintained away from the hazard.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A workpiece handling tool comprising:
a tool head comprising:
a base having a first side and a second side positioned opposite each other; and
a first engagement member and a second engagement member coupled to the base on the first side, the first and second engagement members being spaced from each other at a distance such that the tool head is configured to receive a workpiece between the first and second engagement members, at least one of the first and second engagement members being resiliently bendable such that the at least one of the first and second engagement members bends to accommodate to the workpiece when receiving the workpiece between the first and second engagement members; and
a handle coupled to the tool head, the handle being configured to facilitate grasping of the handle with a hand.

2. The tool of claim 1, wherein the handle is positioned on the second side of the base, the handle being elongated between the tool head and a distal end of the handle with respect to the tool head, the handle forming an acute angle with an axis extending between the first and second engagement members, the handle extending away from the tool head in a direction away from the second engagement member.

3. The tool of claim 1, wherein the handle has a cylindrical shape.

4. The tool of claim 1, wherein the second engagement member comprises a pair of prongs which are spaced from each other.

5. The tool of claim 1, wherein the first engagement member comprises an extension panel and a tooth, the extension panel being coupled to and extending between the base and the tooth, the tooth pointing toward the second engagement member.

6. The tool of claim 5, wherein the extension panel tapers from the base to the tooth.

7. The tool of claim 1, further comprising a grip mounted to a perimeter of the handle to frictionally enhance the handle.

8. The tool of claim 7, wherein the grip comprises a plurality of rings, each ring of the plurality of rings extending around the perimeter of the handle, the plurality of rings being spaced at intervals between the tool head and the distal end.

9. A workpiece handling tool comprising:
a tool head comprising:
a base having a first side and a second side positioned opposite each other; and
a first engagement member and a second engagement member coupled to the base on the first side, the first and second engagement members being spaced from each other at a distance such that the tool head is configured to receive a workpiece between the first and second engagement members, at least one of the first and second engagement members being resiliently bendable such that the at least one of the first and second engagement members bends to accommodate the workpiece when receiving the workpiece between the first and second engagement members, the second engagement member comprising a pair of prongs which are spaced from each other, the first engagement member comprising an extension panel and a tooth, the extension panel being coupled to and extending between the base and the tooth, the tooth pointing toward the second engagement member, the extension panel tapering from the base to the tooth;
a handle coupled to the tool head, the handle being positioned on the second side of the base, the handle being elongated between the tool head and a distal end of the handle with respect to the tool head, the handle forming an acute angle with an axis extending between the first and second engagement members, the handle extending away from the tool head in a direction away from the second engagement member, the handle having a cylindrical shape; and
a grip mounted to a perimeter of the handle to frictionally enhance the handle, the grip comprising a plurality of rings, each ring of the plurality of rings extending around the perimeter of the handle, the plurality of rings being spaced at intervals between the tool head and the distal end.

10. A method of handling a workpiece with a workpiece handling tool, the method comprising:
positioning a first engagement member of a tool head of the workpiece handling tool in abutment with a first surface of the workpiece;
pivoting the tool head about a contact point between the first engagement member and the workpiece, thereby moving a second engagement member of the tool head toward a second surface of the workpiece opposite the first surface;
bending, via pressing against the workpiece, at least one of the first and second engagement members to accommodate the workpiece between the first and second engagement members;
clamping, via the first and second engagement members, the workpiece; and
positioning, via positioning of the workpiece handling tool, the workpiece in a desired position.

11. The method of claim 10, further comprising grasping, via a hand, a handle of the workpiece handling tool.

12. The method of claim 10, wherein the step of positioning the first engagement member of the tool head in abutment with the first surface of the workpiece comprises positioning a tooth of the first engagement member in abutment with the first surface.
